(19) United States
(12) Patent Application Publication
(10) Pub. No.: US 2008/0060328 A1
(43) Pub. Date: Mar. 13, 2008

(54) Filter and filter media

(75) Inventor: Robert Henry Devine, Lee's Summit, MO (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: BHA Group, Inc.

(21) Appl. No.: 11/519,281

(22) Filed: Sep. 12, 2006

(51) Int. Cl. B01D 46/00

(52) U.S. Cl. 55/486

(57) ABSTRACT

One aspect of invention is a filter media for use in a filter having an upstream surface relative to normal airflow through the filter media and an opposite downstream surface. The filter media includes a substrate material selected from the group consisting of nonwoven porous synthetic material, cellulose, and combinations thereof. The substrate is adapted to be positioned in the filter media as the upstream surface. A layer of meltspun fine fibers engaged to the substrate. At least about 85% of the fine fibers have diameters less than 1000 nanometers in diameter. The layer of meltspun fine fibers is adapted to be positioned in the filter media as the downstream surface.

### BACKGROUND OF THE INVENTION

This invention relates generally to filter media, and more particularly to filter media suitable for use in filtration applications.

Many materials and fiber sizes are commonly used in the manufacture of filter media. At least one known media producer applies naturally small size fibers to a surface of a regular paper filter media to enhance its performance. Such fibers are generally less than 1000 nanometers or 1.0 micron in diameter. The fabrication of very small fibers, has been known and practiced for many years. For example, it is common to produce small size fibers using an electrospinning process.

Other than electro-spinning, the only other known common process for producing fine fibers used in filtration are less than 10 microns in diameter (nominally 4-8 microns) is “melt blowing”. Although the cost of melt blowing is relatively low, filter media produced from meltblown small sized fibers are not yet fully commercialized, thus electro-spinning, remains the only known process for making very fine fibers for filtration. The relatively high cost associated with electro-spinning have been an impediment to the greater acceptance of this technology in filtration applications.

One known filter medium comprises a stand-alone, standard corrugated cellulose-based filtration paper, a corrugated synthetic filter paper, and/or a standard corrugated cellulose-based filtration paper that is combined with an electro-statically charged synthetic meltblown layer. However, the known filter media has been found to be of limited use in critical, fine filtration applications in which the media is exposed to a reverse pulse of cleaning air to effect functional performance and longevity. For example, such media may in fact practice depth filtration when a dust cake is formed and embedded in the pore structure or depth of the media. Specifically, as meltblown layer uses a surface filtration technology, wherein the electrostatic forces that impart high filtration efficiency and performance to the media may restrict release of the dust cake during cleaning. As a result, the accumulated dust cake may cause an undesirable pressure drop across the filter assembly in which such media is used.

Another known filter configuration comprises a synthetic fine fiber layer across a surface of a cellulose-based corrugated filter paper. The fine fiber layer is produced using an electro-spinning process in which fine fibers of about 100 nanometers up to a maximum of about 500 nanometers are applied to one surface of the cellulose or synthetic substrate. The applied fibers have a relatively small surface pore structure and are light in weight (usually less than 1.0 g/sq. m.). During use, a dust cake builds across the surface of the applied fine fibers, rather than penetrating into large pores or the depth of known filter paper or synthetic substrate. However, the fragility of such fine fiber filters has generally limited them to use with regenerable filter applications. Moreover, a drawback to the production of filtration media using such fine fiber and other nonwoven media has been the relatively low volume of fine fiber per unit time that can be produced using known processes.

### BRIEF DESCRIPTION OF THE INVENTION

One aspect of invention is a filter media for use in a filter having an upstream surface relative to normal airflow through the filter media and an opposite downstream surface. The filter media includes a substrate material selected from the group consisting of nonwoven porous synthetic material, cellulose, and combinations thereof. The substrate is adapted to be positioned in the filter media as the upstream surface. A layer of meltspun fine fibers engaged to the substrate. At least about 85% of the fine fibers have diameters less than 1000 nanometers in diameter. The layer of meltspun fine fibers is adapted to be positioned in the filter media as the downstream surface to protect the fine fibers from moving particles.

The fine fibers are compressed onto the substrate via a thermomechanical process. The fine fibers comprise at least one material selected from the group consisting of polypropylene, PET, PBT, polyester polymers, Nylon, PPS, and other thermoplastic polymers, and combinations thereof. The layer of fine fibers has a weight of between about 1 to 10 g/m². The substrate has a base weight of between 60 to 340 g/m². The substrate is pleated. The fine fibers have a diameter greater than 500 nanometers.

Another aspect of the invention is a filter cartridge made from filter the media. The filter cartridge includes filter media having an upstream surface relative to normal airflow through the filter media and a downstream surface. Structure supports the filter media. The filter media includes a substrate selected from the group consisting of nonwoven porous synthetic material, cellulose, and combinations thereof the substrate adapted to be positioned in the filter media as the upstream surface. A layer of bulk meltspun fine fibers engaged to said substrate, wherein at least about 85% of said fine fibers have diameters less than 1000 nanometers in diameter the layer adapted to be positioned in the filter media as the downstream surface.

The substrate includes cellulose and said fine fibers comprise at least one material selected from the group consisting of polypropylene, PET, PBT, polyester polymers, Nylon, PPS, and other thermoplastic polymers, and combinations thereof. The fine fibers comprise one of polypropylene and PBT. The layer of fine fibers has a weight of between about 2 to 10 g/m². The substrate has a base weight between approximately 60 to 340 g/m². The fine fibers have a diameter greater than 500 nanometers.

### BRIEF DESCRIPTION OF THE DRAWINGS

FIG. 1 is an elevational view of a filter cartridge made from filter media, according to one aspect of the invention;

FIG. 2 is a cross-sectional view of the filter cartridge of FIG. 1, taken approximately along line 2-2 in FIG. 1; and

FIG. 3 is an enlarged cross-sectional view of the filter media used in the filter cartridge of FIG. 1.

### DETAILED DESCRIPTION OF THE INVENTION

It will be appreciated that at least one aspect of the invention provides an economical filter media and filters constructed therewith. One aspect of the invention utilizes a known process such as that described in any of U.S. Pat. Nos. 4,536,361; 6,183,670 and/or 6,315,806 (the “Torobin process”) to produce very fine fibers. These fibers are then applied to a fabric or paper substrate having specific selected properties, and the substrate and fibers are then calendared or thermo-densified to produce a very cost-effective filter media that is competitive with electrospinning, but has the advantages of increased durability and airflow and at lower operating pressure drops.

The Torobin process is modified by placing the fibers on fabric or paper (or other suitable filter medium) to facilitate enhancing the filter medium and to make the medium and fibers more durable by consolidating the fibers using a calendaring or thermo-densification process. Very fine fibers are thus produced in volume, at manufacturing speed, and applied to one surface of a filter support medium.

The fine fibers facilitate enhancing the performance of the filter medium, and the process facilitates enhancing the durability of the fibers. The durability of filter configurations provided by the invention makes them suitable for a wide range of filter. The relatively fragile fine fibers are protected from particles moving in the airstream to be cleaned by locating them on a downstream surface of the filter media. Thus, the filtration efficiency provided by the fine fiber layer can be maintained for a relatively longer period of time.

According to one aspect of the invention, a composite two-layer filter media 20 (FIG. 3) incorporates a cellulose-based filter paper substrate 22 and a very fine fiber layer 24 that utilizes nano-sized fibers produced by a bulk fine fiber melt spinning process. As used herein, a nano-sized fiber means a fiber having a diameter of less than approximately 1.0 micron or 1000 nanometers. The substrate 22 is located on the upstream side of the filter media 20, relative to the direction of typical flow F of gas through the filter media. The fine fiber layer 24 is located on the downstream side of the filter media 20, relative to the direction of typical flow F to protect the fine fiber layer from particles carried in the gas flow F.

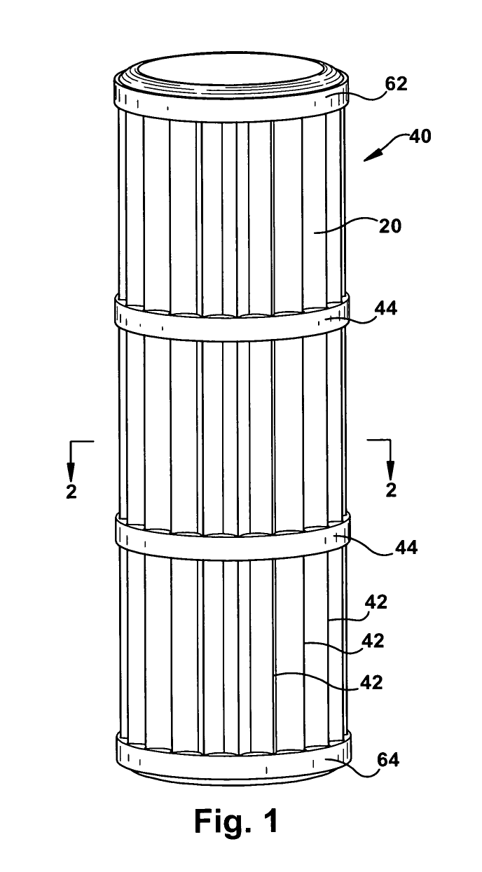

The filter media 20 provides improved functional performance as well as commercial advantages over known comparable and existing products used in various industrial filtration applications. In one aspect of the invention, the filter media 20 is pleated and assembled into a filter cartridge 40 (FIG. 1) for use in industrial applications such as gas turbine intake filtering, laser cutting, fine powder coating applications, etc.

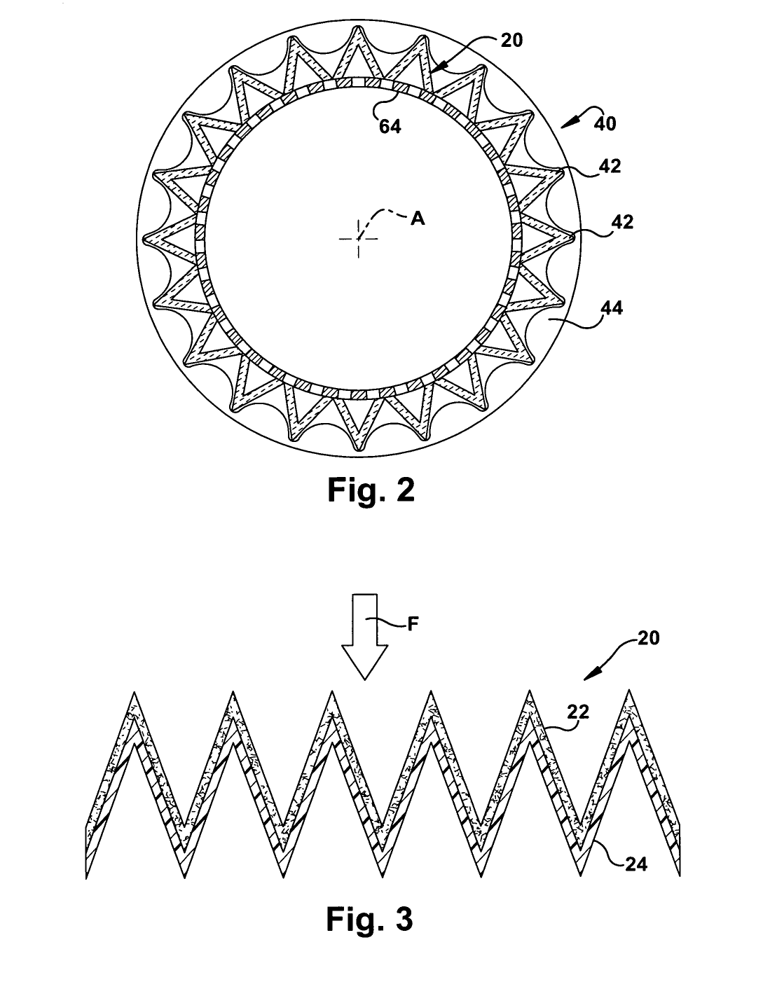

The filter cartridge 40 (FIGS. 1 and 2), according to one aspect of the invention, is for removing particulates from a particulate laden fluid stream F moving one direction through the filter cartridge. While a filter cartridge 40 is shown by way of example, any type of filter can use the filter media 20, such as a panel filter. The filter cartridge 40 is particularly suitable for use in filtering intake air for a gas turbine. The filter cartridge 40 is operably attached to a tube sheet in an intake housing, as is known. The filter cartridge 40 includes the filter media 20 that is pleated, as illustrated in FIG. 3, and formed into a generally tubular or cylindrical configuration with a longitudinal central axis A (FIG. 2). It will be apparent that the filter cartridge 40 may be formed into any suitable shape, such as frusto-conical.

The filter media 20 has plurality of pleats 42 which are circumferentially spaced about the circumference of the filter cartridge 40. The pleats 42 in the filter media 20 are not necessarily stiff and strong, thus, the pleats are prone to radially outward movement during a cleaning fluid pulse. Excessive radial outward movement of the filter media 20 can damage the filtration effectiveness of the filter cartridge 40. Adjacent pleats 26 may also “collapse” and temporarily engage one another during a cleaning pulse or during a filtration cycle. When adjacent pleats 40 engage one another, there is a chance that the cleaning pulse or filtration operation will not be as effective as it should be because gas flow through that portion of the filter media 20 can be temporarily blocked. Thus, it is desirable to prevent excessive radial movement of the filter media 20 and collapse of the pleats 42.

The filter cartridge 40 also includes a retention device in the form of a plurality of retention straps 44 (FIG. 1). The retention straps 44 limit radial movement of the filter media 20 in the radially outward direction, opposite to the flow of the fluid stream to be filtered, when subjected to the periodical cleaning fluid. The retention straps 44 also serve to space apart and maintain adjacent pleats 42 spaced apart around the circumference of the filter cartridge 40.

Mounting structure 62 (FIG. 1) is located at a first axial end portion of the filter media 20 and filter cartridge 40. The mounting structure 62 is made of an elastomeric material for mounting and sealing the filter cartridge 40 in or around an opening in the tube sheet. A known suitable material for the mounting structure 62 is preferably made from a molded urethane material.

An end structure 64 is located at an axially opposite second axial end portion of the filter media 20 and filter cartridge 40. The end structure 64 is preferably made from a molded urethane material and may define an open or closed end, depending on the intended use for the filter cartridge 40. The filter media 20 is potted and maintained in the generally tubular configuration by the mounting structure 62 and the end structure 64. A permeable support 66 (FIG. 2) is located radially inward of the filter media 20 to prevent inward collapse of the filter media during exposure to the particulate laden fluid stream that is to be filtered.

More particularly, some aspects of the invention comprise a composite filter media 20 that includes a corrugated cellulose filtration paper substrate 22 having a known filtration efficiency, and a known air flow capacity having a very fine layer 24 of nano-sized fibers applied the downstream side of the filter media. The fine fiber layer 24 is applied directly to a corrugated cellulose substrate 22 at a high speed production rate. Substrate 22 is corrugated in some configurations, but need not be in all configurations. A meltspinning apparatus, similar to that described in U.S. Pat. No. 6,315,806 to Torobin et al., applies melt-blown fibers 24 to the substrate 22, using a molten polymer fluid supplied through conduit and a fiberizing gas fluid supplied through another conduit.

The applied fine fibers in layer 24 are then densified using a thermal mechanical process, such as calendaring and/or thermal lamination, for example, via rollers. This densification anchors or bonds fine fibers in layer 24 to supporting substrate 22 and enhances the durability and functional life of medium 20. In some configurations, losses in corrugation depth resulting from densification are controlled, reduced, and/or minimized by selecting a suitable type of calendar roll, selecting and/or controlling the applied pressure and temperature of the rolls, and the line speed.

In some aspects of the invention, fiber layer 24 comprises about 85-90% nano-sized fibers ranging from about 0.5 to 0.9 nanometers. Between about 10-15% of the nano-sized fibers can be between approximately 1 micron and 5 microns in diameter. In some configurations, at least about 85% of applied fine fibers in fine fiber layer 24 have diameters less than approximately 1000 nanometers. In some configurations, at least about 90% of applied fine fibers in fine fiber layer 24 have diameters less than approximately 1000 nanometers. In some configurations, at least about 95% of applied fine fibers in fine fiber layer 24 have diameters less than approximately 1000 nanometers. In some configurations, essentially 100% of applied fine fibers in fine fiber layer 24 have diameters less than approximately 1000 nanometers.

The fine fibers in layer 24 are made from polypropylene. Other suitable polymers useful for the applied fine fibers include PET, PBT, other polyester type polymers, NYLON® and other related polymers, PPS, and other thermoplastic polymers, including other polymer fibers used in known industrial filter applications.

Some aspects of the invention provide filtration efficiencies comparable to those of known filter media over relatively long periods of service life. Substrate papers 22 used in some configurations of the present invention are selected or manufactured to have a nominal air permeability of about 45 to 55 cfm at 0.5″ differential pressure (1.274 to 1.557 m³/min at 1.27 cm differential pressure). Cellulose papers known to be used as filter papers in filtering applications have an air permeability between 20 to 30 cfm at 0.5″ differential pressure (0.5663 to 0.8495 m³/min at 1.27 cm differential pressure).

Filtration efficiency can be facilitated to be increased without significantly reducing air flow in some configurations of the present invention by controlling the applied weight of fine fiber layer 24. Target weights between about 2 and 5 g/m² have been found to be especially effective. When fine fiber layer 24 is applied and calendared or densified, these weights allow a reduction of about 12 to 18 cfm at 0.5″ differential pressure (0.3398 m³/min at 1.27 cm differential pressure) in final air permeability. The resulting final air permeability of composite media 20 is thus approximately 30 cfm (0.8495 m³/min) and/or approximately 50% higher than known, comparable products.

By having a lower differential pressure, filters provided by configurations of the present invention allow increased air flow or throughput rates in many applications. Also, cost savings can be achieved because less filter media is needed for substantially the same effective filtering capability, and/or because less energy is needed to clean the filter.

Additional aspects of the invention apply a fine fiber layer 24 to another cellulose based and/or synthetic based (for example, 100% synthetic based) nonwoven substrate 22. In some aspects of the invention, substrate 22 is smooth and/or flat in appearance with no corrugations, and substrate 22 is either corrugated or dimpled during densification or during a pre-pleating step. Some of these configurations allow increased densification that can further improve product and/or process quality, and/or the control of the manufacturing process.

Thus, some aspects of the invention provide a filter medium 20 comprising a substrate 22 and a layer 24 of bulk meltspun fine fibers anchored or bonded to the substrate. Substrate 22 comprises nonwoven synthetic material or cellulose, or a combination thereof. In some configurations, cellulose is combined with an additional stiffening fiber, which can be, for example, glass fiber. Also, at least about 85%, 90%, or 95% of the fine fibers have diameters less than 1000 nanometers in diameter, depending upon the configuration. Fine fibers 30 comprise a thermoplastic, for example, polypropylene, PET, PBT, polyester polymers, NYLON®, PPS, or another thermoplastic polymer, or a combination thereof.

To achieve a suitable air permeability of filter medium 20 for some uses, substrate 22 is selected such that its fibers are produced to have a nominal air permeability (prior to the anchoring of bonding the meltspun fine fibers) between about 45 to 55 cfm at 0.5″ differential pressure (1.274 to 1.557 m³/min at 1.27 cm differential pressure). Also, layer 24 of fine fibers 20 that is applied to substrate 22 has a basis weight of between about 2 to 5 g/m².

In some aspects of the invention, substrate 22 comprises a corrogated cellulose filtration paper having a nominal air permeability between about 45 to 55 cfm at 0.5″ differential pressure (1.274 to 1.557 m³/min at 1.27 cm differential pressure). In some of these aspects, fine fibers is comprised of polypropylene and the layer of fine fibers has a basis weight between about 2 to 5 g/m².

In some configurations of the invention, filter medium 20 is calendared to bond fine fibers in layer 24. Filter medium 20 is then pleated to form a pleated composite filter medium 20. The calendaring of substrate 22 with fine fiber layer 24 allows the bonded fine fibers to remain anchored to substrate 12 in the pleated medium even during and after pleating. More specifically in some aspects of this invention, a thermo-mechanical densification process is used to bond a fine fiber layer to the cellulose substrate 22 to render the fine fiber layer fast to the paper and durable in the application.

The thermo-densification process used in some aspects renders the fine fiber layer 24 both durable and functional when applied to a cellulose based substrate. In some aspects, the thermal densification process is done in-line, as a one step process with the application of the fine fibers.

The thermo densification process uses a combination of both heat and pressure to soften the fine polypropylene or polyester based fibers. Then, via a friction or thermoplastic bond, the fine fibers are adhered to the cellulose based fibers in the paper substrate. The temperature and pressure used to attain the bond is controlled within a range that can be empirically determined for each type of fiber and substrate. The relative smallness of the fine fibers, results in the fibers having very poor thermal insulation properties and hence, poor heat retention properties. Thus, if the process temperature is too hot or the exposure time to the heat is too long, the fine fibers can be thermally degraded and either melt and loose their fiber structure or a level of polymer cross-linking occurs and the fibers may not bond to the cellulose substrate. On the other hand if the temperature is too low or exposure time too short, then poor adhesion may take place and the fine fiber layer may not be suitably durable.

Thermal densification is important for the formation of the fine fiber layer 24 on the surface of the substrate to achieve optimum filtration properties, air permeability and pressure drop characteristics of the overall media. As the fine fiber layer 24 is thermally bonded on to the substrate the fine fiber web is naturally densified to attain a thinner layer, or more of a two dimensional layer of fine fibers, as well as a smaller, tighter pore structure and also a reduction in the air flow properties. The basis weight of the fine fiber layer applied can significantly affect the final air permeability properties.

The process temperature range to achieve durable bond of the fine fiber layer in some configurations is limited. Best bonding of the polypropylene has been observed between 190°-200° F. and around 225°-240° F. for the polyester fibers.

Two methods that can be used to attain a suitable thermal densification process include:

a) A calendaring process between two rolls such as a hot smooth steel roll and a cool synthetic based nip. In this process, both heat and pressure is applied at the same time, rendering the fine fiber layer very durable with a good bond, however, the pressure applied to impart the bond should be controlled to avoid a detrimental effect on the overall media thickness and ultimately, the air flow properties of the filter, in that a loss in corrugation depth of the base media can occur if too much pressure is applied. The heating of the fibers and the bonding occurs at the same point. Depending on temperatures, roll sizes and other process variables, these process configurations, process speeds up to about 20 ft/min are possible.

b) In some configurations, a through-air oven is used, through which the fine fiber web is drawn through the oven via means of a guide belt. At several strategic positions either in or at the exit of the oven, a suitable nip point is located between two heated rolls. This process configuration is similar to the calendar but allows the web to be heated prior to bonding. Thus, higher speeds can be obtained. Further, the pressure used is less because the heat can be applied separately from the bonding points. With less pressure, less deformation of the base media or loss is corrugation is attained. Process speed of up to 200 ft/min. have been found to be possible with this process.

The above-described filter media provide a cost-effective and reliable means to facilitate effective surface filtration. As a result, the improved filter media extend a useful life of the associated filters constructed therewith in a cost-effective and reliable manner.

Exemplary aspects of filter media and filter assemblies are described above in detail. The media are not limited to the specific embodiments described herein, but rather, components of each filter media and of various filter assemblies may be utilized independently and separately from other filter media and filter components described herein.

While the invention has been described in terms of various specific embodiments, those skilled in the art will recognize that the invention can be practiced with modification within the spirit and scope of the claims.

What is claimed is:

1. A filter media for use in a filter having an upstream surface to relative normal airflow through the filter media and a downstream surface filter media comprising:
a substrate selected from the group consisting of nonwoven porous synthetic material, cellulose, and combinations thereof, the substrate adapted to be positioned in the filter media as the upstream surface; and
a layer of meltspun fine fibers engaged to said substrate, wherein at least about 85% of said fine fibers have diameters less than 1000 nanometers in diameter, the layer adapted to be positioned in the filter media as the downstream surface.

2. The filter media of claim 1 wherein said fine fibers are compressed onto said substrate via a thermomechanical process.

3. The filter media of claim 1 wherein said fine fibers comprise at least one material selected from the group consisting of polypropylene, PET, PBT, polyester polymers, Nylon, PPS, and other thermoplastic polymers, and combinations thereof.

4. The filter media of claim 1 wherein said fine fibers comprise one of polypropylene and PBT.

5. The filter media of claim 1 wherein said layer of fine fibers has a weight of between about 1 to 10 g/m².

6. The filter media of claim 1 wherein said substrate has a base weight of between 60 to 340 g/m².

7. The filter media of claim 1 wherein said substrate is pleated.

8. The filter media of claim 1 wherein said fine fibers have a diameter greater than 500 nanometers.

9. A filter comprising;
filter media having an upstream surface relative to normal airflow through the filter media and a downstream surface, structure supporting the filter media,
the said filter media comprising:
a substrate selected from the group consisting of nonwoven porous synthetic material, cellulose, and combinations thereof the substrate adapted to be positioned in the filter media as the upstream surface; and
a layer of bulk meltspun fine fibers engaged to said substrate, wherein at least about 85% of said fine fibers have diameters less than 1000 nanometers in diameter the layer adapted to be positioned in the filter media as the downstream surface.

10. A filter in accordance with claim 9 further wherein said substrate comprises cellulose and said fine fibers comprise at least one material selected from the group consisting of polypropylene, PET, PBT, polyester polymers, Nylon, PPS, and other thermoplastic polymers, and combinations thereof.

11. A filter in accordance with claim 8 wherein said fine fibers comprise one of polypropylene and PBT.

12. A filter in accordance with claim 9 wherein said layer of fine fibers has a weight of between about 2 to 10 g/m².

13. A filter in accordance with claim 8 wherein said substrate has a base weight between approximately 60 to 340 g/m².

14. The filter of claim 9 wherein said fine fibers have a diameter greater than 500 nanometers.

15. The filter of claim 9 wherein said filter media is pleated and formed into a cartridge.
